(19) United States
(12) Patent Application Publication
(10) Pub. No.: US 2012/0261456 A1
(43) Pub. Date: Oct. 18, 2012

(54) APPARATUS AND METHODS FOR INSERTING A FASTENER

(76) Inventors: Christopher John Lacy, Diggers Rest (AU); Darren William Lacy, Kyneton (AU)

(21) Appl. No.: 13/500,191

(22) PCT Filed: Oct. 5, 2010
(86) PCT No.: PCT/AU10/01298

§ 371 Date: Jun. 25, 2012

Related U.S. Application Data
(60) Provisional application No. 61/272,546, filed on Oct. 5, 2009.

(51) Int. Cl. B25C 5/00; B25B 31/00

(52) U.S. Cl. 227/139; 156/66

(57) ABSTRACT

The present invention provides a hand-held device for the insertion of fasteners into the ground for the purpose of anchoring sheet-like materials such as geotechnical mats for soil stabilization, and also for securing netting to prevent crop wastage. The device includes an anti-jamming mechanism that lessens the frequency of fastener jamming thereby increasing the work efficiency of an operator and saving wastage of fasteners.

### FIELD OF THE INVENTION

This invention relates generally to a device for the insertion of fasteners into the ground for the purpose of anchoring sheet-like materials such as geotechnical mats in soil or stabilization or agricultural netting for the protection of crops.

### BACKGROUND TO THE INVENTION

Soil erosion can be a serious problem resulting in damage to water sources, landscaping, and wildlife. During construction works of residential and commercial infrastructure projects, vegetation, which protects soil from erosion, is often removed. Exposure of soils to the erosive forces of wind and rain can carry soil, sediment, organic matter and nutrients into stormwater. Soil erosion and sedimentation can be considered as one of the largest pollutants by volume in stormwater and generally in water run-off. It is therefore widely recognised that the control and prevention of soil erosion will aid in providing an improvement in general water quality and limit the impact on aquatic fauna and flora in receiving waterways.

Similarly, the revegetation of natural ecosystems and the control of weeds or other unwanted flora are of growing concern for many individuals. Weeds can often compete with productive crops or pasture, can be harmful to domesticated plants and livestock, and can convert productive land into unusable scrub. The use of chemical treatments or herbicides while often effective, has also been recognised as potentially damaging to fragile soil systems or be otherwise harmful to those exposed during application. Aside from risks of exposure at the site of application, other factors such as pesticide drift or water pollution can occur upon employment of pesticide treatments, whereby surrounding areas other than the target area can invariably be contaminated.

It is recognised that the repair of damage caused by soil erosion and weed management is not only difficult, but time consuming. The use of blankets or matting for purposes of either erosion control or the management of regeneration areas has been proposed as a potential solution to these problems. These systems may be highly effective when compared to other forms of management such as mulch in reducing run-off during rain events. Such mats or blankets, generally constructed from biodegradable substances such as straw, coconut, or wood fibre are placed onto prepared soils and areas to prevent them washing away.

Netting and similar barriers are often used to exclude birds and other animals from food crops. These physical barriers provide significant advantages to farmers or viticulturists by improving yields of viable and marketable crops. The installation of bird netting is generally accomplished by stretching out the net over the desired crop. To ensure complete coverage, the netting is typically anchored to the ground by a weighted object or latched to the ground by a tie or fastener.

The installation of matting and netting as described above, is time consuming and laborious. Typically, the method for anchoring matting is by insertion of fasteners through the matting into the underlying soil. Such fasteners can take the form of nails, pins, staples, U-shaped wires, stakes, or other similar objects. While the insertion of fasteners is often the most direct method for matting securement, it is a labour intensive process whereby each fastener is introduced by hand or in combination with a hammer depending on the hardness of the underlying topsoil. Furthermore, as installation of erosion control blankets often occurs on sloped or inclined areas, it will often ensue that installing fasteners by hand can cause excessive strain to the operators, such as injury to their back, joints or muscles, or other regions of their body due to the repetitive nature of the operation. This is especially evident when the topology of the underlying ground is uneven, at an incline, or when the underlying soil is considerably hard.

It is recognised that portable and semi-portable hand-operable devices exist in the art for the insertion of fasteners for the securing of mats and netting to the ground. These devices aid in automating the insertion of fasteners by pushing the fasteners into the ground upon actuation of a hammer, shaft, piston or similar structure that makes contact with the fastener. While such devices provide an advantage over inserting the fasteners manually with a hammer, these devices are prone to jamming. Typically, fasteners are fed into hand-operable devices by a spring-loaded magazine. However, the magazine can incorrectly feed fasteners into the device such that the presence of multiple fasteners leads to jamming. Once jammed it is necessary for the operator to dismantle the device, remove the fasteners responsible for the jamming, and reassemble the device before returning to work. It will be clear that multiple episodes of jamming will adversely affect the productivity of a worker installing matting and netting, and also lead to the wastage of many fasteners. It has been noticed that the problem of jamming is especially prevalent in novice operators of these devices.

Applicant has discovered that jamming of fasteners in these devices is often caused by operators not fully expelling a fastener from the device and into the ground with a single movement of the hammer. Thus, an operator (and particularly a novice operator) may effect multiple downstrokes and upstrokes of the device hammer in order to fully seat the fastener into the ground. However, in the process of effecting multiple blows, the hammer is withdrawn upwardly by the operator, thereby leaving the fastener guide capable of accepting a new fastener from the magazine. The operator then effects a further downstroke in an attempt to fully seat the first fastener, but instead engages the second fastener. The second fastener is then forced downward toward the first fastener (which is still not completely expelled from the device) with both fasteners being forced to co-occupy a space within the device designed to accommodate a single fastener. This cycle may recur such that 3, 4, 5 or more fasteners co-occupy the space. It will be understood that existing devices are relatively closely toleranced, such that the device is easily blocked in the aforementioned circumstances.

It would be desirable to provide a device for the insertion of fasteners into ground that is less prone to jamming when compared to existing devices. It would also be desirable to provide a magazine of fasteners that is less likely to lead to jamming of existing devices.

### SUMMARY OF THE INVENTION

In a first aspect the present invention provides a hand-operable device for inserting a fastener into a substrate, the device comprising: a fastener holder; a fastener guide coupled to the fastener holder, a fastener pushing arrangement for pushing the fastener from the fastener holder along the guide and toward the substrate, and a moveable guard for regulating the movement of a fastener from the fastener holder to the fastener guide to prevent more than a single fastener accumulating in the fastener guide.

Applicant proposes that inclusion of a moveable guard adapted to regulate the entry of a fastener into the fastener guiding means overcomes or at least partially alleviates the problem of jamming as described above in respect of existing arrangements.

In one embodiment of the device, the guard blocks the passage of a fastener to the guide until a fastener already present in the guide has been substantially fully seated into the substrate. In this way, the operator is able to effect multiple downstrokes and upstrokes without a new fastener being admitted into the guide before the existing fastener is completely seated.

The moveable guard may be of any shape or configuration so long as it able to effectively block the guide, while leaving the guide open and free to accept a fastener, while all the time not impeding the movement or function of any other parts of the device. In one form of the device, the moveable guard has a shape or configuration such that it is capable of being seated in and moving within the guide, in a manner similar to a fastener. In another embodiment, the guard has the same or similar dimensions to a fastener that may be used with the device. Preferably, the moveable guard is fabricated from a material or finished to provide a relatively low friction surface. Given the function of the moveable guard to act as a barrier to the entry of more than a single fastener at a given time, it will be understood that a material of particularly high strength is not required.

The moveable guard may be fabricated of a material being substantially or completely synthetic. Indeed, it may be selected from any one of, but not limited to, any metal, nylon, teflon, rubber, cork, high molecular weight polyethylene or be a plastic or plastic composite or any other synthetic polymers or polyamides or thermoplastic fibre that possess abrasion resistance properties.

In operation, the moveable guard is capable of moving between an open and closed position. The open position allows a fastener to be urged into the guide, while the closed position prohibits the entry of a fastener. In devices of the present invention, the guide is typically elongate with the fastener holding means delivering a fastener to a fastener accepting region of the guide. In one embodiment of the device, the moveable guard is capable of moving between a first position occupying a space in the fastener accepting region of the guide (thereby blocking the entry of a fastener to the guide) to a second position distal to the fastener accepting region (thereby permitting the entry of a fastener to the guide).

In one form of the device, this regulation is achieved by the moveable guard being adapted or configured to block the entry of a fastener into the guide until the pushing arrangement has extended downward substantially completely. Once the pushing arrangement has effected a substantially complete downstroke, the pushing arrangement engages with the moveable guard on the upstroke, thereby shifting the moveable guard from the fastener accepting region to a distal position such that the fastener accepting region is unblocked and therefore capable of accepting a fastener.

In one form of the device, the regulation is effected by the pushing arrangement being releasably engageable with the moveable guard. Under this arrangement, the pushing arrangement is incapable of engaging with the moveable guard on an upstroke of the pushing arrangement until the pushing arrangement has already been substantially completely extended in a downwards direction on the previous downstroke. Thus, where the operator has not completely seated the fastener into the ground with a single downstroke, and the operator then effects an upstroke (in order to effect a second downstroke), the pushing arrangement does not engage with the moveable guard on the upstroke resulting in the guard remaining in a position blocking the fastener receiving region of the guide. Accordingly, no further fastener can be admitted into the guide. By contrast, where the operator has fully seated the fastener with a single downstroke, on the subsequent upstroke, the pushing arrangement releasably engages the guide with the upwards movement of the guide urging the moveable guard from a position blocking the fastener receiving region of the guide, upwards to a position where the receiving region is open.

The releasable engagement between the guide and the moveable guard may be effected by any suitable arrangement. For example, the releasable engagement may be provided by an electromagnetic arrangement such that activation of an electromagnet fixed to either the pushing arrangement or moveable guard causes engagement of the two parts, while deactivation of the electromagnet causes disengagement. In one embodiment, an electronic position sensor is fitted to the pushing arrangement, such that a positive signal is generated by the sensor when the pushing arrangement is substantially completely extended downwardly. This may be achieved by mounting a simple reed switch on a distal portion of the guide, with the magnetic trigger being placed on the distal terminus of the pushing arrangement (i.e. the portion that contacts the fastener). The positive signal that is generated by sensor when the pushing arrangement is substantially completely extended may (via a relay) activate the electromagnet such that on the upstroke the moveable guard and pushing arrangement engage. In order to disengage the two parts a second reed switch may be positioned marginally above the fastener receiving region, such that once the distal terminus of the pushing arrangement is moved higher than the fastener receiving region on the upstroke, the second reed switch is triggered leading to the deactivation of the electromagnet which in turns releases the pushing arrangement from the guide.

In one embodiment of the device, the releasable engagement is provided by a mechanical arrangement such as a bearing or a roller fitted with a biasing arrangement, the roller capable of releasably engaging with a recess or edge of the opposing part. The biasing arrangement ensures that the bearing or roller is urged toward the floor of the recess or edge, leading to a suitable engagement of the two parts.

The recess may be substantially triangular such that when moving in a first direction relative to the opposing part, the roller moves down the slope of the triangle but is prevented from moving further by the base of the triangle. This acts to effectively engage the pushing arrangement and the moveable guard such that further upward movement of the pushing arrangement also results in the upward movement of the moveable guard to leave the fastener receiving region of the guide to accept a fastener. On the downstroke, the roller is able to move in the reverse direction and roll freely against the opposing part thereby disengaging the parts.

The recess may be substantially a right angle cut out of an upper corner of the pushing arrangement (or hammer). By this arrangement, when the pushing arrangement is being moved upwardly during an upstroke, the moveable guard is also moved upward by engagement of a roller on the guard. Once the guard has travelled as far as possible, with further upward movement of the pushing arrangement, the roller moves out of the recess and rolls along the side of the pushing arrangement thereby effectively disengaging the two parts.

It will be understood that the moveable guard need not necessarily be a dedicated component of the device. For example, the pushing arrangement may also act as the moveable guard. In one embodiment, the device is configured such that the upward movement of the pushing arrangement is limited until the pushing arrangement is extended substantially completely downwards. Thus, the pushing arrangement is prevented from moving upwards to an extent sufficient to unblock the fastener receiving region (and able to receive a new fastener) until the existing fastener is completely expelled from the device and fully seated into the substrate. It will be apparent from this embodiment that there is no requirement for a dedicated moveable guard, with the pushing arrangement being capable of achieving the task of hammering the fastener into the substrate as well as blocking the fastener receiving region while the operator effects multiple blows on the fastener.

In one form of the device, the movement of the combined pushing arrangement/moveable guard is limited by a spring-loaded catch. The catch may be biased toward an open position, but is normally maintained in a closed position to prevent upward movement of the combined pushing arrangement/moveable guard to the extent that the fastener receiving region is unblocked. Once extended downwardly to an extent sufficient to expel a fastener, the combined pushing arrangement/moveable guard trips the spring-loaded catch, thereby moving the catch to an open position. Opening of the catch allows the combined pushing arrangement/moveable guard to retract upwardly to the extent that the fastener receiving region of the guide is unblocked. On the following downward stroke, movement of the combined pushing arrangement/moveable guard acts to close and reload the spring-loaded catch.

The combined pushing arrangement/moveable guard may communicate with the spring-loaded catch by way of two protuberances on the combined pushing arrangement/movable guard; one protuberance in a position (relative to the catch) indicating that the fastener has been expelled from the device, with the second in a position (relative to the catch) indicating that the fastener receiving region is unblocked and capable of receiving a new fastener. The movement of the protuberances past the catch acts to alternately open and close the catch at the relevant times in the upstroke and downstroke of the device.

Any guide described herein may be fabricated from a metal such as aluminium, or an aluminium alloy selected from the group consisting of duralumin, magnox and silumin; or comprising an alloy of aluminium comprising a metal selected from the group consisting of copper, zinc, manganese, silicon or magnesium. In another form of the device, the guide is composed of a material of such as a heavy duty plastic, synthetic resin, or other suitable synthetic material of sufficient durability.

The device may include any or all of the features that are present in similar existing devices. Such devices known to the applicant are described in U.S. Pat. No. 6,926,186. For example, the fastener pushing arrangement may be part of an elongated handle secured in a shaft to a main body that, at the base, is attached to an arrangement capable of pushing a fastener. The shaft and handle may be configured to push a fastener from the fastener holder, along the guide and into a substrate. The handle may be secured in a shaft which possesses an internal mechanism (such as a spring) to return the handle to the original retracted position, wherein a fastener guide is coupled to the fastener holder and a fastener pushing arrangement is connected to the elongated handle.

A further aspect of the present invention provides a magazine of fasteners, wherein the individual fasteners are maintained en bloc using a glue and/or a gum and/or paper and/or a tape. The Applicant has discovered that existing fasteners known to them that are collated or held together in close proximity by welding to a wire often cause fastener insertion devices to block either due to dislodgment of the wire within the fastener pushing arrangement, or as a result of the wire welding distorting the orientation of the fasteners. This damage often requires repair, unexpected downtime, delays, and often produces irreparable damage to the fastener insertion devices in the art. Applicant has discovered that collation of fasteners using paper and/or tape in combination with a gum and/or glue provides improvement compared to the existing fastener magazines known to them, whereby the problems of jamming or causing damage to the fastener insertion devices is abrogated.

In one form of the invention, the composition of the glue is a spray adhesive with a high level of solids (approximately 10%-30% w/w) that is formulated to be highly heat resistant up to temperatures in excess of 50° C., and is capable of forming bonds on metals, heavy papers, wood and most plastics. In one embodiment of the invention, the glue selected to maintain the fasteners en bloc is the industrial grade spray adhesive 3M Scotch-Weld™ Hi-Strength Spray Adhesive 98NF. In yet another form of the invention, a suitable adhesive is combined with a kraft paper such that the paper and adhesive combine and when applied to the fasteners, secure the fasteners and provide limited movement when en bloc. In a further form of the invention, the kraft paper used is approximately 30 g/m². In yet another form of the invention, the kraft paper used can be selected from any number of kraft papers ranging from 30 g/m² to 100 g/m².

The Applicant has discovered that selecting a suitable combination of adhesive and paper ensures that the action of separating the fastener from the magazine of fasteners by the fastener pushing arrangement does not cause blockage or interference inside the fastener insertion device. Under elevated working temperatures the applicant has observed that an adhesive that is not of high heat tolerance invariably becomes more viscous and looses bonding. Such effects of adhesive failure result in the paper separating from the fastener and therefore the paper becomes trapped within the pushing arrangement after the fastener is ejected from the fastener magazine by action of the pushing arrangement. The Applicant has considered that the adhesive be suitably chosen to ensure that adequate bonding is constantly provided between the adhesive, paper or tape, and the fasteners such that the fastener insertion device can be operated in temperatures between 35° C. and 45° C. degrees without detriment to the securement of the fasteners en bloc. The fasteners may be of any shape or composition so far as they are suitable for the desired used. In one form of the invention, the fasteners are substantially staple-shaped, and composed of a metal such as mild or high tensile steel. In another form of the invention, the fasteners can have a length of at least approximately 50 mm or at least approximately 100 mm or at least approximately 150 mm or at least approximately 200 mm.

In an alternative form of the present invention, the fasteners may be substantially shaped to form a stake or be substantially ‘T’ shaped, Such stakes or ‘T’ shaped fasteners can be similarly maintained or collated en bloc using one or more of wire, glue, gum and tape.

In a further form of the present invention, the fasteners may take the shape of any of the previous embodiments but be composed of a material that is not metal. In such a form, the fasteners may be composed of a resin or of high density polymer such as a plastic. In another additional form, the material selected for the fasteners may be chosen based on the available biodegradable characteristics of the material, such that if a biodegradable matting or blanket is it to be utilised, a similarly biodegradable fastener of similar biodegradable properties can used.

In a further aspect the present invention provides a kit of parts comprising a device as described herein and a magazine of fasteners as described herein. The kit optionally includes other articles such as matting, and/or instructions for use.

Yet a further aspect of the invention provides a method of inserting a fastener into a substrate, the method comprising use of a device, and/or a magazine of fasteners and/or a kit as described herein. In one embodiment of the method, the method comprises the steps of inserting a magazine of fasteners as described herein into a device as described herein; and actuating the fastener pushing arrangement such that a fastener is inserted into the substrate.

It will be convenient to hereinafter describe a preferred embodiment of the invention with reference to the accompanying drawings. The particularity of the drawings is to be understood as not limiting the preceding broad description of the invention.

### BRIEF DESCRIPTION OF THE DRAWINGS

FIG. 1A shows a perspective view of an assembled device of the invention, placed on the ground in its normal working orientation. 1B is the same view as FIG. 1A but with the magazine removed.

FIG. 2 is an internal view of the device with the moveable guard removed and inverted to show the arm and roller mechanisms underneath. The sliding hammer is not shown in this view.

FIG. 3 is an internal view of the device, assembled with the guard. The sliding hammer is not shown in this view.

FIG. 4 is an internal view of the device showing the guard completely retracted upwardly and the sliding hammer on a downward stroke and engaging the guard.

FIG. 5 is an internal view of the device showing disengagement of the sliding hammer and the guard. A, B, and C show the relative positions of the roller and the sliding hammer over time as the sliding hammer is moved in a downwards direction.

FIG. 6 is an internal view of the device showing partial expulsion of a first fastener, while the guard is preventing the entry of a second fastener into the guide means.

FIG. 7 is an internal view of the device showing the sliding hammer on a downward movement and almost completely extended downwardly.

FIG. 8 is an internal view of the device showing the positions of the guard, sliding hammer and fastener after an upstroke. The guard has been retracted to allow entry of a fastener into the guiding means.

### DETAILED DESCRIPTION OF THE PREFERRED EMBODIMENT(S)

Description of the figures is presented to show the sequential positioning of the various elements of the anti-jamming mechanism during a downward stroke, followed by an upward stroke of the device. In the context of the description below (and claims), the term “downward” is intended to mean toward the ground and “upward” is intended to mean “away from the ground”. It will be recognised however that the device may be used to insert a fastener into a horizontally disposed or sloped substrate or even in a completely inverted orientation to that shown in the figures.

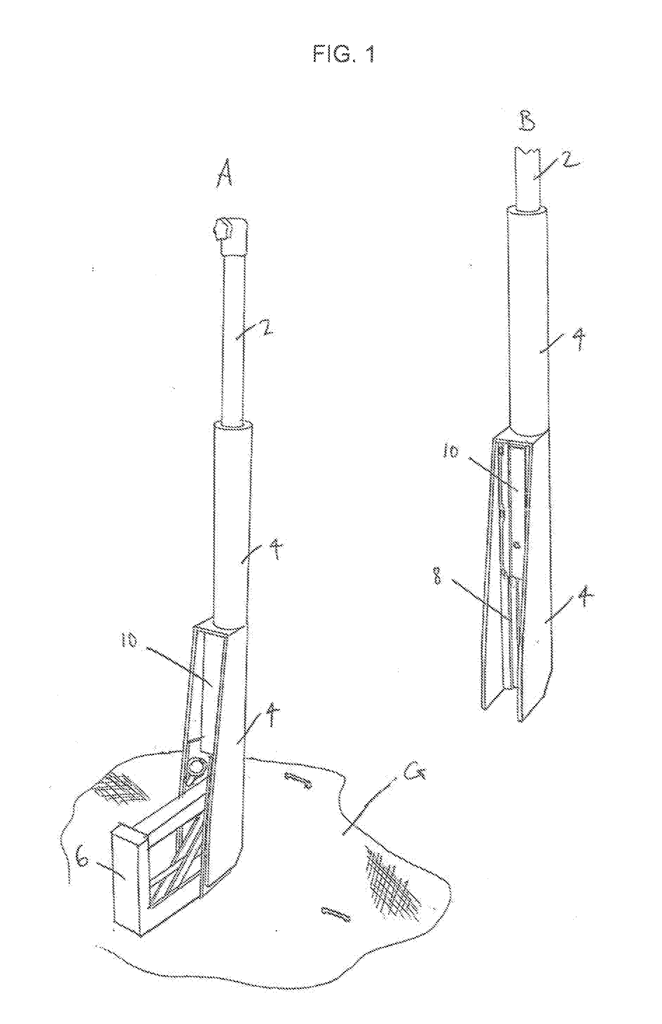

Referring to FIG. 1, an assembled device A and partially disassembled device B according to the present invention is shown. The device is shown resting on the ground G in the orientation in which it is normally used. The device has a reciprocating shaft 2 (handle not shown) moveable relative to the housing 4 by the operator, the shaft being connected to a fastener pushing arrangement in the form of the sliding hammer 10. A fastener holder in the form of detachable magazine 6 carries a plurality of fasteners, with a spring in the magazine (not shown) acting to urge the fasteners toward the fastener/guard guide 8. The fastener/guard guide 8 is a recess of sufficient depth to guide both the guard and the fasteners (not shown in this view). The sliding hammer 10 is operable in an upward and downward motion by the operator via longitudinal upstrokes and downstrokes of the shaft 2. In use, the reciprocating shaft 2 is urged by the operator in a downwards motion to expel a fastener from the housing, and at least partially into the ground G. Given the incorporation of an anti-jamming mechanism into the device, the reciprocating shaft 2 may effect multiple upstrokes and downstrokes to fully seat a first fastener into the ground G before a second fastener is admitted into the fastener/guard guide 8.

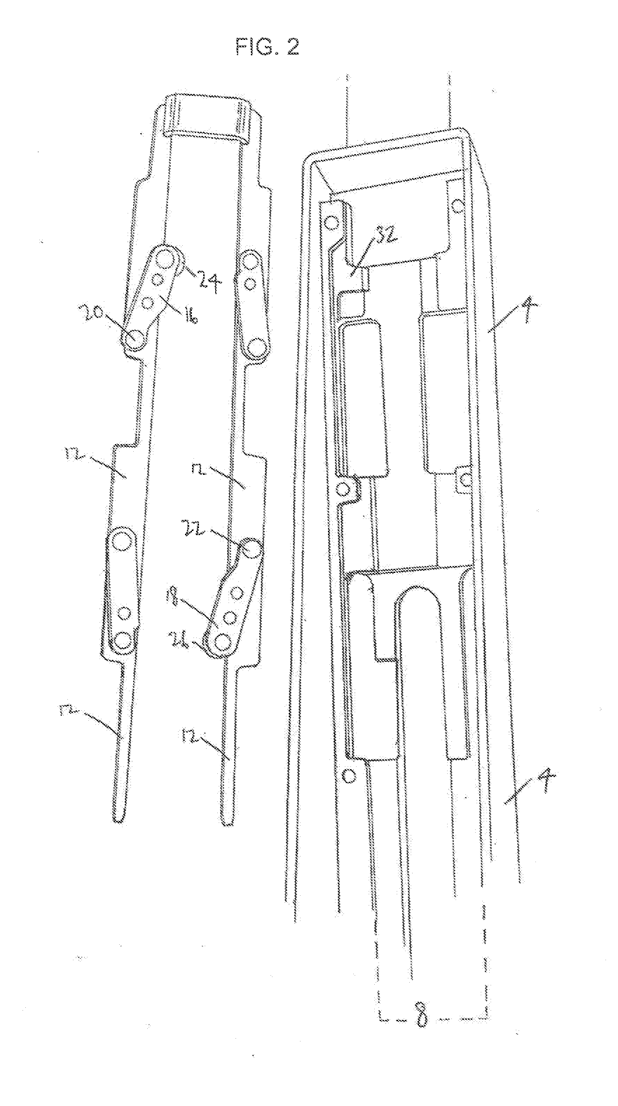

FIG. 2 is a partially disassembled view of the device, showing the underside of the moveable guard 12 and the position of the guard 12 relative to the housing 4 and the fastener/guard guide 8. The pair of narrow terminal members of guard 12 lie within the fastener/guard guide 8, and are capable of sliding within the guide. The moveable guard 12 is fitted with two arms 16 and 18, the arms 16 and 18 pivoting about the points 20 and 22 respectively. Each arm 16 and 18 is fitted with springs (not shown) that act to bias the arms 16 and 18 inwards and toward the edges of sliding hammer (not shown in this view). Toward the end of each of the arms 16 and 18 are rollers 24 and 26 respectively. A stop 32 is present to limit the travel of the guard 12 in the downward direction.

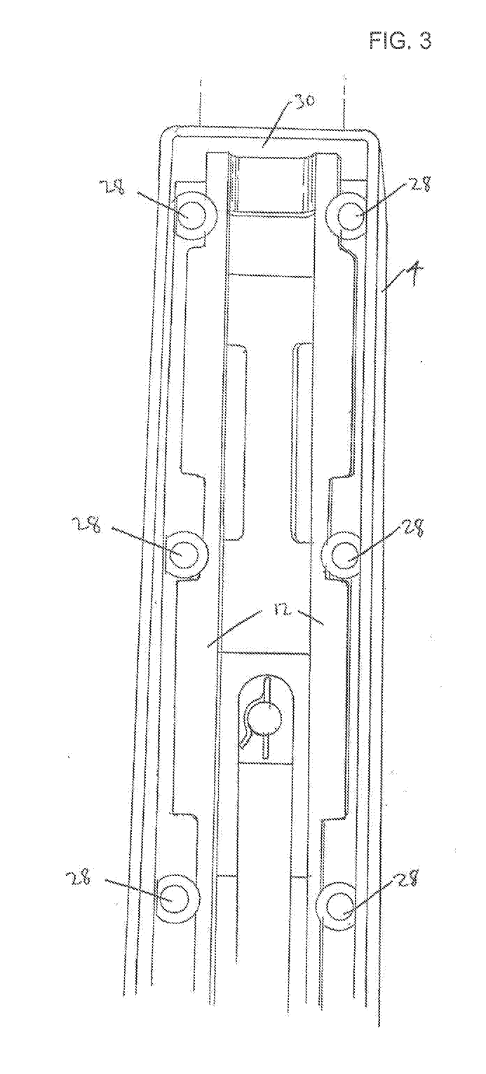

FIG. 3 shows the housing 4 and guard 12 assembled. The guard 12 is positioned under guides 28, and is capable of longitudinal movement between the wall of the housing 30 and the stop 32 (stop 32 is visible in FIG. 2 only).

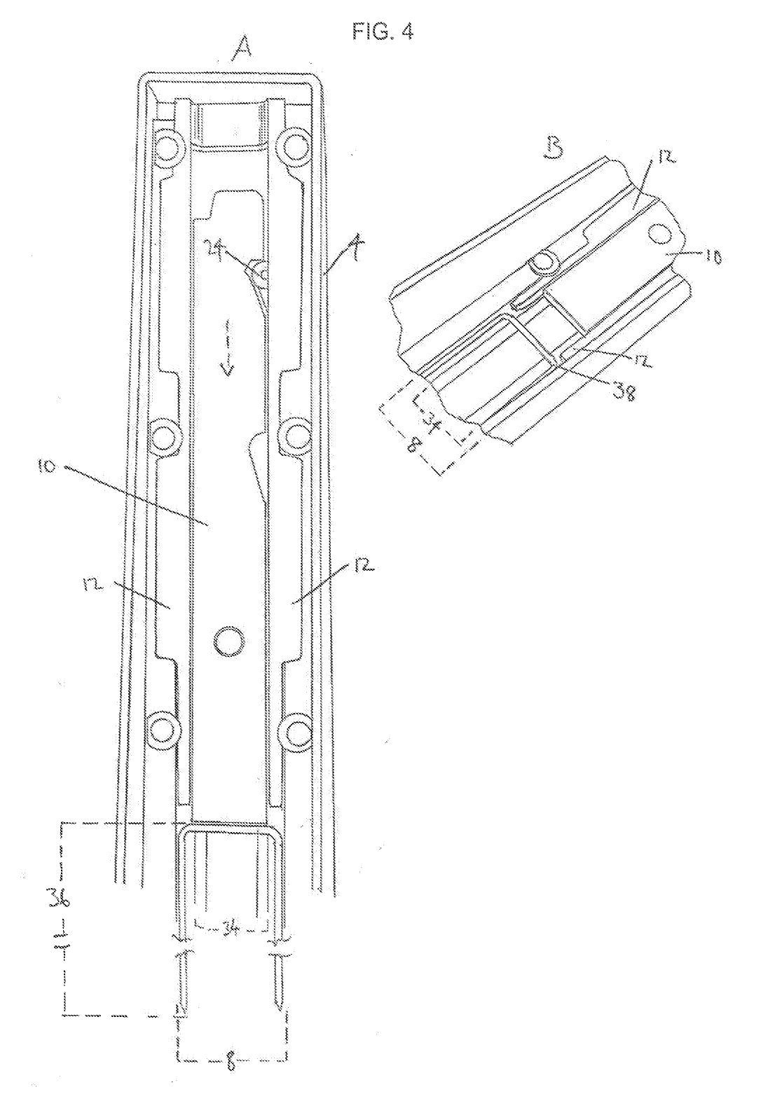

FIG. 4 shows the housing 4, guard 12 and sliding hammer 10. The sliding hammer 10 is disposed between the two terminal elongate members of the guard 12, and is guided by the sliding hammer guide 34. The guard 12 is in its highest position and the sliding hammer 10 is also elevated such that the fastener accepting region 36 of the fastener/guard guide 8 is open to accept the fastener 38. The roller 24 has releasably engaged the sliding hammer 10 in so far as when the sliding hammer 10 is urged downwards by the operator, the guard 12 will be engaged with the sliding hammer 10 (via the roller 24) thereby urging the guard 12 downwards to block the fastener accepting region 36.

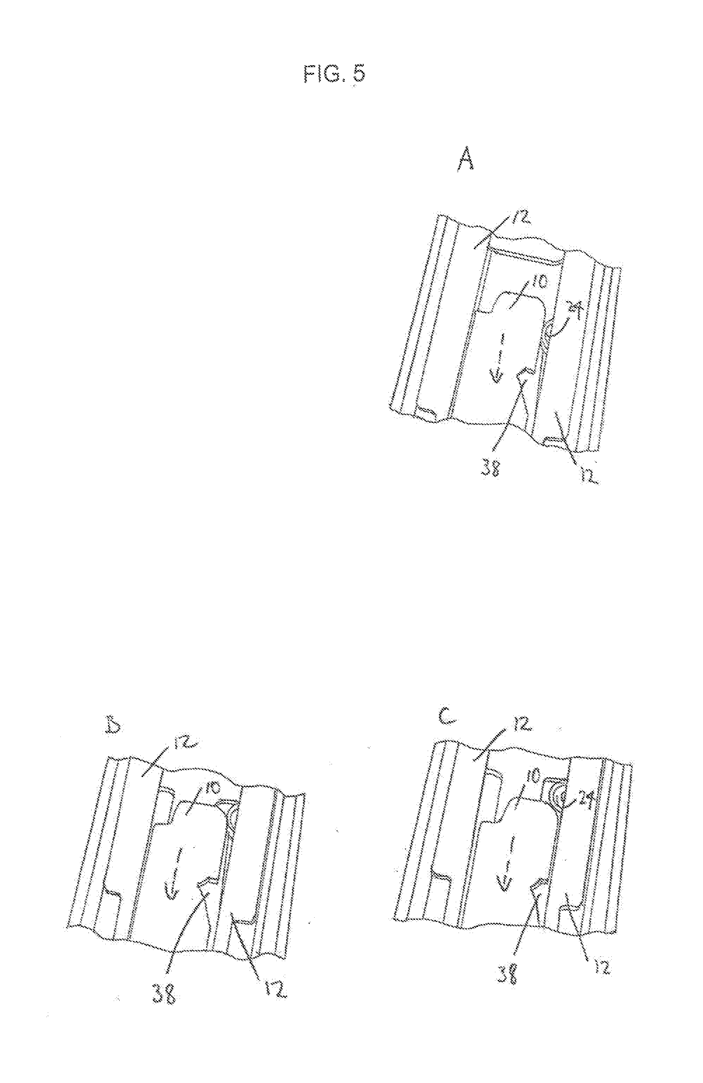

The next step is shown in FIG. 5, where the guard 12 has hit the stop 32 (not shown in this view) and can travel no further downwards. With the guard 12 now stationary and the sliding hammer 10 still being urged downwards by the operator, the roller 24 or 26 rolls out of the recess 38, and rolls along the edge of the sliding hammer (A and B) until the roller 24 or 26 completely disengages with the sliding hammer 10.

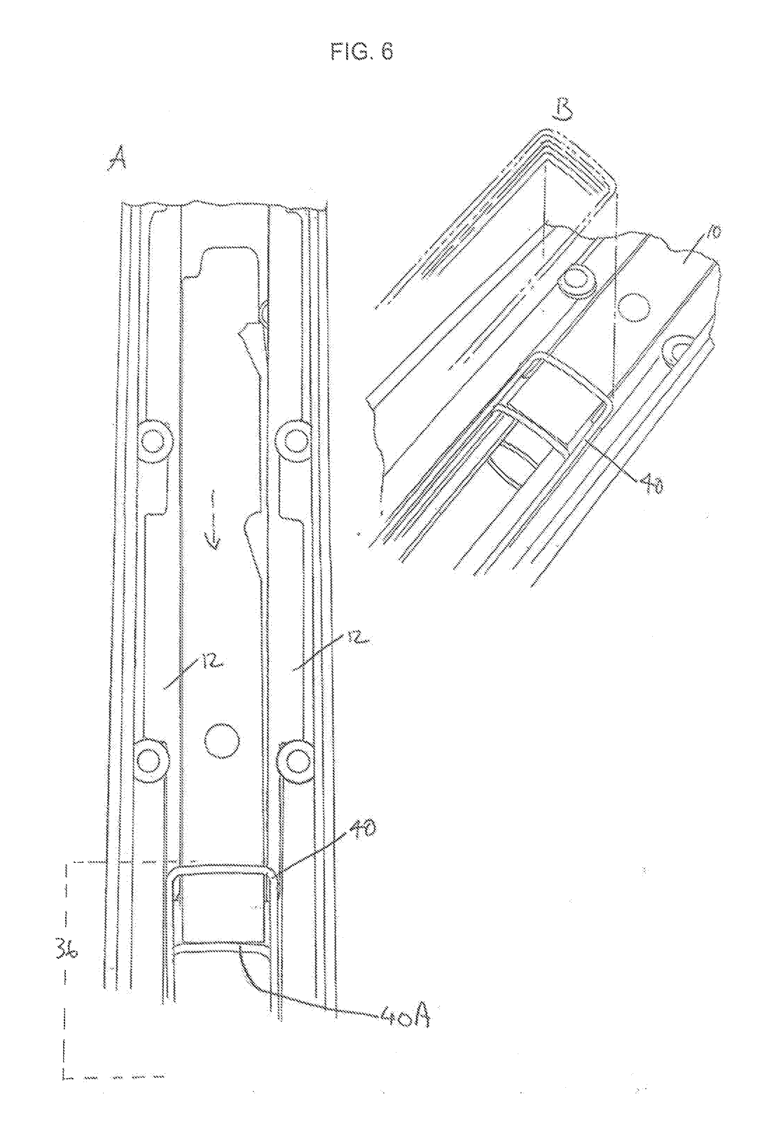

FIG. 6 shows that with the guard 12 moved downwards, the fastener accepting region 36 is blocked to prohibit the entry of second fastener 40 while the first fastener 40A is being fully seated in the ground with multiple blows of the sliding hammer 10 by the operator.

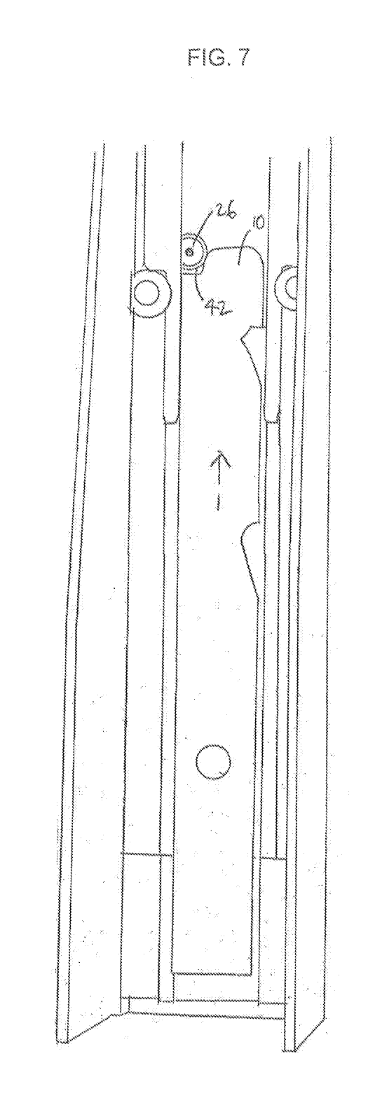

FIG. 7 shows the arrangement where the sliding hammer 10 is almost completely extended downwardly. This can only occur when the fastener is (not illustrated in FIG. 7) completely or almost completely seated in the ground. The roller 26 is then capable of releasably engaging with the sliding hammer 10 when, on the reciprocal stroke, the sliding hammer 10 is urged upwards. This engagement via recess 42 and roller 26 causes the guard 12 to move upwards and out of the fastener receiving region 36 of the fastener/guard guide 8. This upward movement of the guard 12 continues until the guard is stopped by the wall of the housing 30.

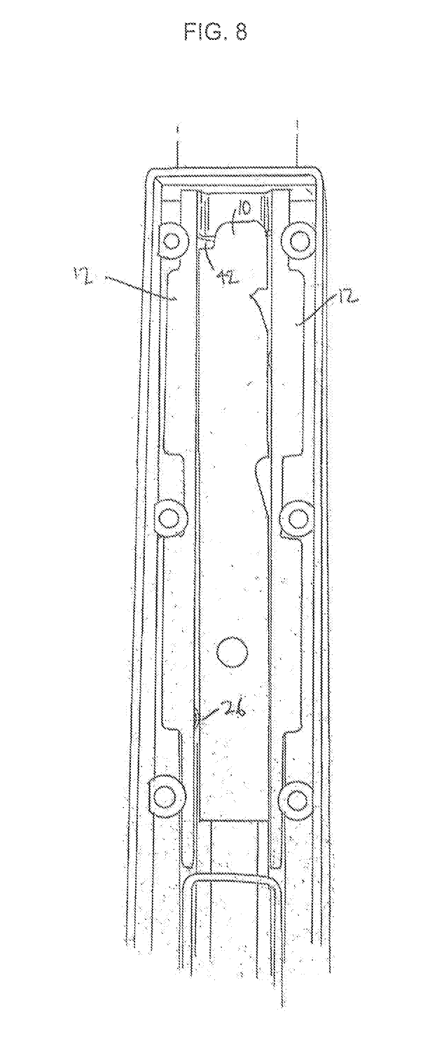

FIG. 8 shows the sliding hammer 10 at its highest position in the upstroke. At this point, the guard 12 is fully retracted leaving the fastener accepting region 36 open and able to receive a new fastener. With the sliding hammer still being urged upwards by the operator, the roller 26 is forced to retract and roll along the edge of the sliding hammer 10.

Having reached the high point in the upstroke, the sliding hammer 10 then commences the reciprocal downward stroke, thereby re-engaging with the guard 12 by roller 24 entering recess 38 (i.e. returned to the same position as in FIG. 4). Upon this engagement, further movement of the sliding hammer 10 downward lowers the guard 12 into the fastener receiving region 36 of the fastener/guard guide 8, thereby preventing the entry of a further fastener into the guide.

From the above it will be clear that by the described arrangement of two sets of rollers and recesses, the sliding hammer 10 is capable of releasably engaging the guard 12. The timing of the engagement and disengagement is achieved by the relative positions of the rollers and recesses. The engagement and disengagement is dependant on the shape of the recesses, such that engagement and disengagement can occur selectively depending on the direction of movement of the sliding hammer 10 relative to the guard 12.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention as broadly described herein.

Throughout the description of this specification the word “comprise” and variations of that word, such as “comprises” and “comprising”, are not intended to exclude other additives or components or integers.

1. A hand-operable device for inserting a fastener into a substrate, the device comprising: fastener holder; fastener guide coupled to the fastener holder, fastener pushing arrangement adapted to push the fastener from the fastener holder along the guide and toward the substrate, and a moveable guard adapted to regulate the entry of a fastener into the fastener guide such that multiple fasteners are not permitted to accumulate in the fastener guide.

2. A device according to claim 1 wherein the guard is adapted to block the entry of a fastener into the guide until another fastener already present in the guide has been substantially fully seated into the substrate.

3. A device according to claim 1 wherein the moveable guard has a shape or configuration such that it is capable of being seated in and moved within the guide.

4. A device according to claim 1 wherein the moveable guard is adapted or configured to block the entry of a fastener into the guide until the pushing arrangement has extended downward substantially completely.

5. A device according to claim 1 wherein the pushing arrangement is releasably engageable with the moveable guard.

6. A device according to claim 5 wherein the releasable engagement is provided by a bearing or a roller fitted with a biasing means mounted to one of the pushing arrangement and moveable guard, the roller capable of releasably engaging with a recess or edge in the other of the pushing arrangement and moveable guard.

7. A device according to claim 6 wherein the engagement or disengagement is dictated by (i) the shape of the recess or edge and (ii) the direction of movement of the pushing arrangement relative to the moveable guard.

8. A device according to claim 6 wherein timing of the engagement and disengagement within a complete cycle of activation is dictated by the position of the recess or edge on one of the pushing arrangement and moveable guard relative to the position of the bearing or roller on the other of the pushing arrangement and moveable guard.

9. A device according to claim 1 wherein the pushing arrangement also acts as the moveable guard.

10. A magazine of fasteners, wherein the individual fasteners are maintained en bloc using at least one of wire, glue, gum and tape.

11. A magazine of fasteners according to claim 10, wherein the fasteners have a length of at least approximately 50 mm or at least approximately 100 mm or at least approximately 150 mm or at least approximately 200 mm.

12. A magazine of fasteners according to claim 10 wherein the fasteners are substantially staple-shaped or are substantially T-shaped.

13. A magazine of fasteners according to claim 10, wherein the fasteners are composed of a metal or of a high-density polymer.

14. A method for manufacturing a magazine of fasteners, the method comprising the steps of providing a plurality of fasteners, positioning the fasteners to form a magazine, and applying at least one of glue, gum, and tape to the fasteners to secure the fasteners en bloc.

15. A method according to claim 14 wherein the fasteners have a length of at least approximately 50 mm or at least approximately 100 mm or at least approximately 150 mm or at least approximately 200 mm.

16. A method according to claim 14 wherein the magazine of fasteners is adapted for use in a fastener insertion device of claim 1.

17. A kit of parts comprising a device according to claims 1 and a magazine of fasteners wherein individual fasteners are maintained en bloc using at least one of wire, glue, gum and tape.

18. (canceled)

19. (canceled)
